(19) United States
(12) Patent Application Publication
(10) Pub. No.: US 2024/0280311 A1
(43) Pub. Date: Aug. 22, 2024

(54) Food Or Beverage Item Container Cooling Assembly And Method Of Use

(71) Applicant: Miechel Barksdale, Hillsboro, OR (US)

(72) Inventor: Miechel Barksdale, Hillsboro, OR (US)

(21) Appl. No.: 18/110,441

(22) Filed: Feb. 16, 2023

(51) Int. Cl. F25D 3/00; A47J 41/00; F25D 31/00

(52) U.S. Cl. CPC F25D 3/00; A47J 41/0044; F25D 31/002

(57) ABSTRACT

A food or beverage item container cooling assembly for limiting warming of the food or beverage item includes a shell, which has an open top. The shell comprises an outer wall and an inner wall, which define an internal space. The internal space is substantially occupied by a substance having a latent heat of fusion that is equal to or greater than that of water. The shell can be positioned in a freezer to substantially fuse the substance. The shell is one of a plurality of shells, each having a respective shape and a respective size, thereby providing shells of a variety of shapes and sizes. A complementarily shaped container containing a food or beverage item is insertable into the shell. The substance absorbs heat from the complementarily shaped container to limit warming of the respective food or beverage item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooling assemblies and more particularly pertains to a new cooling assembly for limiting warming of the food or beverage item. The present invention discloses a cooling assembly comprising a plurality of shells, each being configured for insertion of a complementarily shaped container containing a food or beverage item. The shell limits warming of the respective food or beverage item.

### (2) Description of Related Art Including Information Disclosed Under 37 CFR 1.97 and 1.98

The prior art relates to cooling assemblies, which may comprise cooling packs for insertion into food or beverage containers, envelops with integral cooling packs, foldable cooling packs for positioning around food or beverage containers, wine bottle chillers, lunch box liners, or the like. What is lacking in the prior art is a cooling assembly comprising a plurality of shells, each having a respective shape, a respective size, and an open top. A substance positioned between inner and outer walls of the shell is freezable. A complementarily shaped container containing a food or beverage item is insertable into the shell, allowing the substance to absorb heat to limit warming of the food or beverage item.

### BRIEF SUMMARY OF THE INVENTION

An embodiment of the disclosure meets the needs presented above by generally comprising a shell, which has an open top. The shell comprises an outer wall and an inner wall, which define an internal space. The internal space is substantially occupied by a substance having a latent heat of fusion that is equal to or greater than that of water. The shell is configured to be positioned in a freezer to substantially fuse the substance. The shell is one of a plurality of shells, with each shell having a respective shape and a respective size so that the plurality of shells comprises shells having a variety of shapes and a variety of sizes. Each shell is configured for insertion of a respective complementarily shaped container of a plurality of complementarily shaped containers, each containing a respective food or beverage item. The substance is configured to absorb heat from the respective complementarily shaped container to limit warming of the respective food or beverage item.

Another embodiment of the disclosure includes a method for limiting warming of a food or beverage item. Provision steps of the method entail providing a food or beverage item container cooling assembly, according to the disclosure above, and a container containing a food or beverage item. Operational steps of the method are selecting a shell from the plurality of shells that is sized and shaped complementary to the container, positioning the shell in a freezer to substantially fuse the substance, inserting the container into the shell, and allowing the substance to absorb heat from the container to limit warming of the food or beverage item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a food or beverage item container cooling assembly according to an embodiment of the disclosure.

FIG. 2 is an isometric perspective view of an embodiment of the disclosure.

FIG. 3 is an in-use view of an embodiment of the disclosure.

FIG. 4 is an in-use view of an embodiment of the disclosure.

FIG. 5 is a cross-sectional view of an embodiment of the disclosure.

FIG. 6 is an in-use view of an embodiment of the disclosure.

FIG. 7 is an in-use view of an embodiment of the disclosure.

FIG. 8 is an isometric perspective view of an embodiment of the disclosure.

FIG. 9 is a flow diagram for a method utilizing of an embodiment of the disclosure.

### DETAILED DESCRIPTION OF THE INVENTION

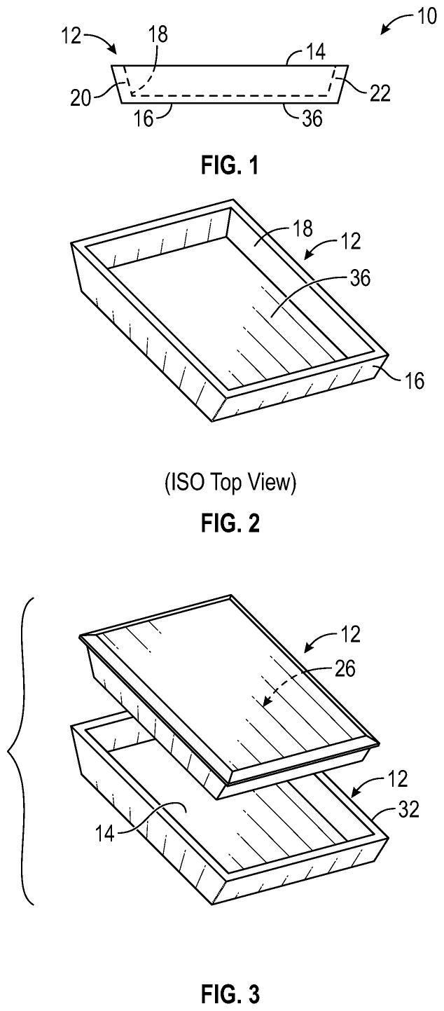

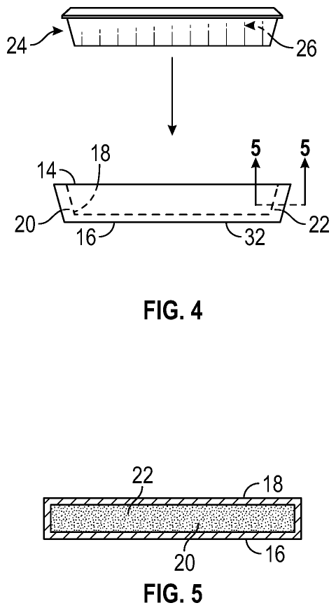

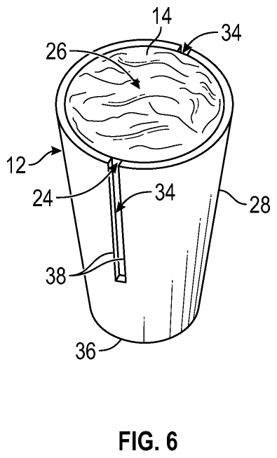

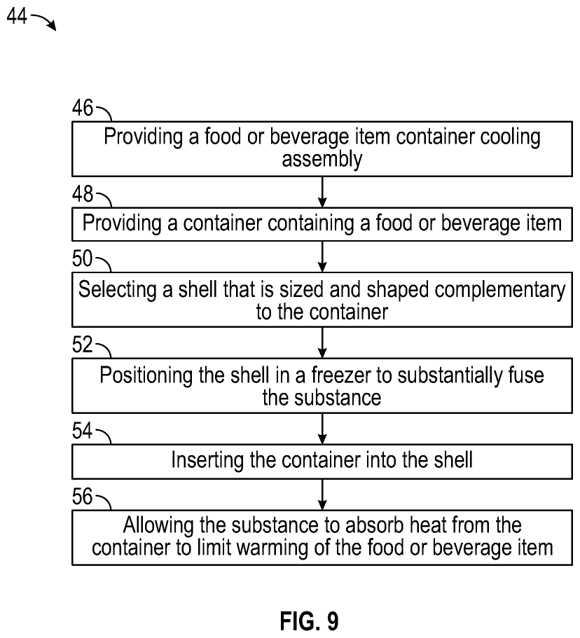

With reference now to the drawings, and in particular to FIGS. 1 through 9 thereof, a new cooling assembly embodying the principles and concepts of an embodiment of the disclosure and generally designated by the reference numeral 10 will be described.

As best illustrated in FIGS. 1 through 9, the food or beverage item container cooling assembly 10 generally comprises a shell 12, which has an open top 14 and which comprises silicone, elastomer, or the like. The shell 12 comprises an outer wall 16 and an inner wall 18, which define an internal space 20. The internal space 20 is substantially occupied by a substance 22 having a latent heat of fusion that is equal to or greater than that of water. The substance 22 may comprise water with or without one or more of hydroxyethyl cellulose, sodium polyacrylate, vinyl coated silica gel, or the like. The shell 12 is configured to be positioned in a freezer to substantially fuse the substance 22.

As shown in FIGS. 2, 7, and 8, the shell 12 is one of a plurality of shells 12, with each shell 12 having a respective shape and a respective size so that the plurality of shells 12 comprises shells 12 having a variety of shapes and a variety of sizes. Each shell 12 is configured for insertion of a respective complementarily shaped container 24 of a plurality of complementarily shaped containers 24, each containing a respective food or beverage item 26. The substance 22 is configured to absorb heat from the respective complementarily shaped container 24 to limit warming of the respective food or beverage item 26. The present invention is anticipated to be useful in a variety of situations wherein cooling of a food or beverage item 26 is required, such as, but not limited to, cooling food or beverage items 26 for a meal that is to be eaten at a later time. Such may be the case when packing a lunch meal in the morning. Additional applications of the food or beverage item container cooling assembly 10 include positioning of catering trays or bowls into complementarily shaped shells 12 to maintain the food or beverage items 26 that they contain at an acceptable temperature.

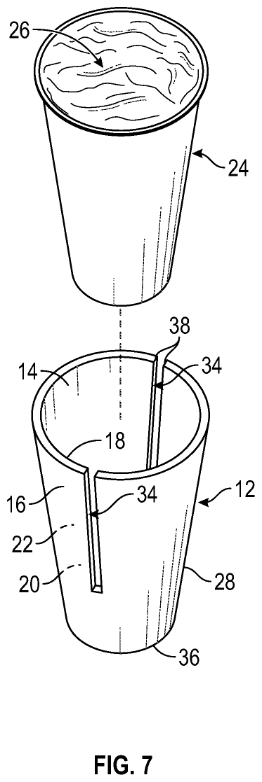

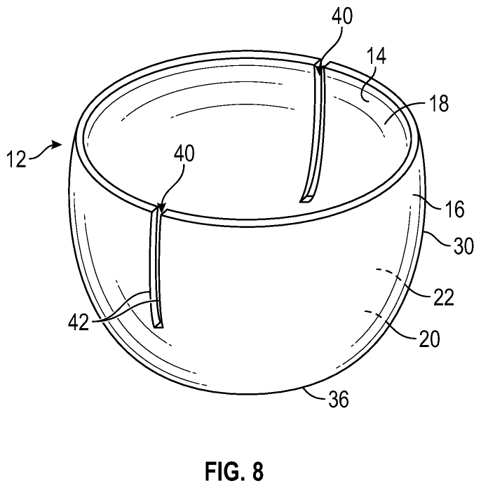

The plurality of shells 12 may comprise a first shell 28, a second shell 30, and a third shell 32. As shown in FIG. 7, the first shell 28 is sized and shaped complementarily to a conically frustrum shaped container 24. Such containers 24 often are used to contain yogurts, puddings, or the like. As shown in FIG. 8, the second shell 30 is sized and shaped complementarily to a bowl shaped container 24, such as might be used to contain punches, salads, or the like. As shown in FIGS. 2 and 3, the third shell 32 is sized and shaped complementarily to a substantially cuboid container 24, such as might be used by caterers. The present invention also anticipates additional shells 12 that are shaped complementarily to other containers 24.

As shown in FIG. 7, a set of first slits 34 is positioned in the first shell 28. Each first slit 34 extends from the open top 14 toward a bottom 36 of the first shell 28. Opposed edges 38 of the first slit 34 are configured to be separated to facilitate insertion of the conically frustrum shaped container 24 into the first shell 28 and extraction of the conically frustrum shaped container 24 from the first shell 28. The set of first slits 34 may comprise two first slits 34, which are opposingly positioned in the first shell 28.

As shown in FIG. 8, a set of second slits 40 is positioned in the second shell 30. Each second slit 40 extends from the open top 14 toward the bottom 36 of the second shell 30. Opposing edges 42 of the second slit 40 are configured to be separated to facilitate insertion of the bowl shaped container 24 into the second shell 30 and extraction of the bowl shaped container 24 from the second shell 30. The set of second slits 40 may comprise two second slits 40, which are opposingly positioned in the second shell 30.

In use, the food or beverage item 26 container 24 cooling assembly enables a method for limiting warming of a food or beverage item 44. The method 44 comprises a first provision step 46, which entails providing a food or beverage item container cooling assembly 10, according to the specification above. A second provision step 48 of the method 44 is providing a container 24 containing a food or beverage item 26. A first operational step 50 of the method 44 is selecting a shell 12 from the plurality of shells 12 that is sized and shaped complementary to the container 24. A second operational step 52 of the method 44 is positioning the shell 12 in a freezer to substantially fuse the substance 22. A third operational step 54 of the method 44 is inserting the container 24 into the shell 12. A fourth operational step 56 of the method 44 is allowing the substance 22 to absorb heat from the container 24 to limit warming of the food or beverage item 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food or beverage item container cooling assembly comprising:
a shell having an open top, the shell comprising an outer wall and an inner wall defining an internal space;
a substance positioned in and substantially occupying the internal space, the substance having a latent heat of fusion which is equal to or greater than that of water; and
the shell being one of a plurality of shells, each shell of the plurality of shells having a respective shape and a respective size, such that the plurality of shells comprises shells having a variety of shapes and a variety of sizes, wherein each shell of the plurality of shells is configured for insertion of a respective complementarily shaped container of a plurality of complementarily shaped containers each containing a respective food or beverage item, wherein the shell is configured for positioning in a freezer for substantially fusing the substance, wherein the substance is configured for absorbing heat from the respective complementarily shaped container for limiting warming of the respective food or beverage item.

2. The food or beverage item container cooling assembly of claim 1, wherein the shell comprises silicone or elastomer.

3. The food or beverage item container cooling assembly of claim 1, wherein the substance comprises water.

4. The food or beverage item container cooling assembly of claim 3, wherein the substance comprises one or more of hydroxyethyl cellulose, sodium polyacrylate, and vinyl coated silica gel.

5. The food or beverage item container cooling assembly of claim 1, wherein the plurality of shells comprises:
a first shell sized and shaped complementarily to a conically frustrum shaped container;
a second shell sized and shaped complementarily to a bowl shaped container; and
a third shell sized and shaped complementarily to a substantially cuboid container.

6. The food or beverage item container cooling assembly of claim 5, further including:
a set of first slits positioned in the first shell, each first slit of the set of first slits extending from the open top toward a bottom of the first shell, wherein opposed edges of the first slit of the set of first slits are configured for being separated for facilitating insertion of the conically frustrum shaped container into the first shell and extraction of the conically frustrum shaped container from the first shell; and
a set of second slits positioned in the second shell, each second slit of the set of second slits extending from the open top toward the bottom of the second shell, wherein opposing edges of the second slit of the set of second slits are configured for being separated for facilitating insertion of the bowl shaped container into the second shell and extraction of the bowl shaped container from the second shell.

7. The food or beverage item container cooling assembly of claim 6, wherein:
the set of first slits comprises two first slits opposingly positioned in the first shell; and
the set of second slits comprises two second slits opposingly positioned in the second shell.

8. A food or beverage item container cooling assembly comprising:
a shell having an open top, the shell comprising an outer wall and an inner wall defining an internal space, the shell comprising silicone or elastomer;
a substance positioned in and substantially occupying the internal space, the substance having a latent heat of fusion which is equal to or greater than that of water, the substance comprising water, the substance comprising one or more of hydroxyethyl cellulose, sodium polyacrylate, and vinyl coated silica gel;
the shell being one of a plurality of shells, each shell of the plurality of shells having a respective shape and a respective size, such that the plurality of shells comprises shells having a variety of shapes and a variety of sizes, wherein each shell of the plurality of shells is configured for insertion of a respective complementarily shaped container of a plurality of complementarily shaped containers each containing a respective food or beverage item, wherein the shell is configured for positioning in a freezer for substantially fusing the substance, wherein the substance is configured for absorbing heat from the respective complementarily shaped container for limiting warming of the respective food or beverage item, the plurality of shells comprising:
a first shell sized and shaped complementarily to a conically frustrum shaped container,
a second shell sized and shaped complementarily to a bowl shaped container, and
a third shell sized and shaped complementarily to a substantially cuboid container;
a set of first slits positioned in the first shell, each first slit of the set of first slits extending from the open top toward a bottom of the first shell, wherein opposed edges of the first slit of the set of first slits are configured for being separated for facilitating insertion of the conically frustrum shaped container into the first shell and extraction of the conically frustrum shaped container from the first shell, the set of first slits comprising two first slits opposingly positioned in the first shell; and
a set of second slits positioned in the second shell, each second slit of the set of second slits extending from the open top toward the bottom of the second shell, wherein opposing edges of the second slit of the set of second slits are configured for being separated for facilitating insertion of the bowl shaped container into the second shell and extraction of the bowl shaped container from the second shell, the set of second slits comprising two second slits opposingly positioned in the second shell.

9. A method for limiting warming of the respective food or beverage item comprising the steps of:
providing a food or beverage item container cooling assembly comprising:
a shell having an open top, the shell comprising an outer wall and an inner wall defining an internal space,
a substance positioned in and substantially occupying the internal space, the substance having a latent heat of fusion which is equal to or greater than that of water, and
the shell being one of a plurality of shells, each shell of the plurality of shells having a respective shape and a respective size, such that the plurality of shells comprises shells having a variety of shapes and a variety of sizes;
providing a container containing a food or beverage item;
selecting a shell from the plurality of shells that is sized and shaped complementary to the container;
positioning the shell in a freezer to substantially fuse the substance;
inserting the container into the shell; and
allowing the substance to absorb heat from the container to limit warming of the food or beverage item.

10. The method of claim 9, wherein the shell comprises silicone or elastomer.

11. The method of claim 9, wherein the substance comprises water.

12. The method of claim 11, wherein the substance comprises one or more of hydroxyethyl cellulose, sodium polyacrylate, and vinyl coated silica gel.

13. The method of claim 9, wherein the plurality of shells comprises:
a first shell sized and shaped complementarily to a conically frustrum shaped container;
a second shell sized and shaped complementarily to a bowl shaped container; and
a third shell sized and shaped complementarily to a substantially cuboid container.

14. The method of claim 13, further including:
a set of first slits positioned in the first shell, each first slit of the set of first slits extending from the open top toward a bottom of the first shell, wherein opposed edges of the first slit of the set of first slits are configured for being separated for facilitating insertion of the conically frustrum shaped container into the first shell and extraction of the conically frustrum shaped container from the first shell; and
a set of second slits positioned in the second shell, each second slit of the set of second slits extending from the open top toward the bottom of the second shell, wherein opposing edges of the second slit of the set of second slits are configured for being separated for facilitating insertion of the bowl shaped container into the second shell and extraction of the bowl shaped container from the second shell.

15. The method of claim 14, wherein:
the set of first slits comprises two first slits opposingly positioned in the first shell; and
the set of second slits comprises two second slits opposingly positioned in the second shell.
